(19) United States
(12) Patent Application Publication
(10) Pub. No.: US 2013/0282401 A1
(43) Pub. Date: Oct. 24, 2013

(54) SYSTEM AND METHOD FOR MANAGING THE TRACKING AND DISPENSING OF PRESCRIPTION MEDICATION

(71) Applicant: LTC PHARMACY SOLUTIONS, LLC, Tupelo, MS (US)

(72) Inventors: David Summers, Collierville, TN (US); Douglas M. Wright, JR., Saltillo, MS (US); Mark Holley, Pontotoc, MS (US)

(21) Appl. No.: 13/913,687

(22) Filed: Jun. 10, 2013

Related U.S. Application Data
(63) Continuation-in-part of application No. 13/028,385, filed on Feb. 16, 2011.

(51) Int. Cl. G06F 19/00; G06Q 50/24

(52) U.S. Cl. CPC G06F 19/3456; G06Q 50/24
USPC 705/3

(57) ABSTRACT

A system is provided for tracking and dispensing of prescription medication. A secure website is provided and a data communication link to a computer at each healthcare facility and pharmacy. Prescriptions are ordered from the healthcare facility computer, after which labels with machine readable code are generated by the pharmacy computer for each prescription container. A verification table is generated of all ordered prescriptions over a predetermined time to each respective healthcare facility, a reader scans the machine readable code of each prescription container, and the pharmacy computer verifies that all ordered prescriptions are sorted for delivery. The verification table of the verified prescriptions sorted for delivery is uploaded to a database. Upon delivery at the healthcare facility, the verification table is downloaded from the database, a reader scans the machine readable code of each prescription container, and the healthcare facility computer verifies that all ordered prescriptions were received.

### CROSS-REFERENCE TO RELATED APPLICATIONS

This application is a Continuation-In-Part of U.S. application Ser. No. 13/028,385 filed Feb. 16, 2011, and incorporated herein by reference in its entirety.

### BACKGROUND OF THE INVENTION

The present invention relates to prescription medication and, more particularly, to a system and method for managing the transport of prescription medication between two locations and an inventory of prescription medication at a location.

Healthcare facilities, such as assisted-living facilities, nursing homes or hospitals, house multiple patients may require prescription medication on a regular basis. Typically, the healthcare facilities contact a remote pharmacy with prescription medication orders, after which the pharmacy fills medication containers to fulfill the prescription medication orders, and ships the prescription medication to the healthcare facility. However, common issues arise with this routine process. For example, not all of the prescription medication orders may be filled and thus not all of the prescription medication may be shipped to the healthcare facility. Additionally, for example, the pharmacy may fill medication containers to fulfill all of the prescription medication orders, but may accidentally ship some of the prescription medication to the wrong healthcare facility. Additionally, for example, the pharmacy may ship all of the prescription medication to the correct healthcare facility, but some of the prescription medication may be lost or stolen by workers or other individuals at the healthcare facility.

Various processes have been proposed in an effort to address the above drawbacks in regard to shipping prescription medications to healthcare facilities. For example, U.S. Patent Application Publication No. 2006/0054682 to de la Huerga discloses a process for tracking the shipment of prescription medication. However, the process disclosed in de la Huerga requires that all of the prescription medication orders shipped to a specific healthcare facility are provided with an identical label and, thus, each specific prescription medication order cannot be tracked to the specific location.

Accordingly, it would be advantageous to provide a process which addresses the drawbacks discussed above in regard to the management of the transport of prescription medication to a healthcare facility.

### BRIEF DESCRIPTION OF THE INVENTION

In one embodiment of the present invention, a system is provided for tracking and dispensing of medication relating to prescriptions from a pharmacy to multiple healthcare facilities. The system includes a secure website and one or more data communication links between one or more computers at each healthcare facility and the website. The system also includes one or more data communication links between one or more computers at the pharmacy and the website for the transfer of prescription data between the healthcare facilities and the pharmacy. Prescriptions are ordered from the healthcare facilities via the website. The system also includes a first computer at the pharmacy for generating prescription labels for medication containers in response to the prescription data received from each healthcare facility. The labels have a machine readable code of the prescription data including a prescription number, a patient's name, the healthcare facility, an identification of a drug prescribed, and a medication dosage.

The first computer, or a second computer in communication with the first computer, generates a verification table of the prescriptions ordered over a predetermined time period for each healthcare facility. The verification table is displayed on the first or second computer monitor and includes the prescription data for each healthcare facility received over the predetermined time. The system also includes one or more first readers that are linked to the first computer, or a second computer at the pharmacy, for reading the machine readable code on the prescription labels after the medication containers have been filled and sorted by each respective healthcare facility. The first or second computer is configured with software to compare the prescription data received from the machine readable code to the prescription data on the verification table for the respective healthcare facility in order to verify that all prescriptions ordered for the respective healthcare facility have been filled and sorted for delivery. The system also includes a database containing data relative to each healthcare facility including the name and location of the healthcare facility, the name of each patient relative to each healthcare facility, medication information associated with each patient including the type and dosage for the medication, and a shipment status of the prescriptions. The prescription data of the verification table is uploaded to the database from the first or second computer and the shipment status is uploaded to the database upon verification that all of the ordered prescriptions for each healthcare facility have been properly sorted for shipment.

The system also includes a third computer at the healthcare facility and one or more second readers that are linked to the third computer which is configured to access the database to download the prescription data. A second verification table is displayed on the third computer monitor, and the one or more second readers are configured to read the machine readable code on the prescription labels of medication containers delivered to the healthcare facility. The third computer is configured to compare the prescription data from the machine readable code with the prescription data in the verification table for the healthcare facility to verify that all prescriptions ordered by the healthcare facility over the predetermined time period have been received at the healthcare facility. The third computer is configured to update the shipment status of the database upon receiving and reading the labels of the containers.

In another embodiment of the present invention, a method is provided for tracking and dispensing of medication relating to prescriptions from a pharmacy to multiple healthcare facilities. The method includes generating prescription labels at the pharmacy for medication containers in response to prescription orders received from each healthcare facility. The labels have a machine readable code for prescription data including a prescription number, a patient's name, the healthcare facility, an identification of a drug prescribed, and a medication dosage. The method also includes storing the prescription data on a computer. The method also includes scanning the machine readable code on the prescription labels after the medication containers have been filled and sorted according to each respective healthcare facility. The method also includes comparing the data received from the machine readable code to the stored prescription data for the respective healthcare facility in order to verify that all prescriptions ordered for the respective healthcare facility have been filled and sorted for delivery. The method also includes providing a database containing prescription data relative to each healthcare facility including a prescription number, the name and location of the healthcare facility, the name of each patient relative to each healthcare facility, medication information associated with each patient including the type and dosage for the medication, and a shipment status of the prescriptions. The method also includes updating the database with the prescription data and the shipment status upon verification that all of the ordered prescriptions for each healthcare facility have been sorted according to the respective healthcare facilities. Upon receipt of the medications at a healthcare facility, the method includes reading the machine readable code on the prescription labels of medication containers delivered to the healthcare facility. The method also includes comparing the prescription data from the machine readable code to the prescription data in the database for the healthcare facility to verify that all prescriptions ordered by the healthcare facility over the predetermined time period have been received at the healthcare facility. The method also includes updating the shipment status of the database upon receiving and reading the prescription labels of the medication containers.

In another embodiment of the present invention, a method is provided for tracking and dispensing of prescription medication from a pharmacy to multiple healthcare facilities and to patients at the facilities. The method includes providing a machine readable code on a prescription label for a prescription filled at the pharmacy for each patient at each healthcare facility. The machine readable code includes data relative to a prescription number and for each prescription number there is data relative to the name of the patient, name of the healthcare facility where the patient is located, identification and dosage of a medication associated with the prescription and the date the prescription was filled. The method further includes applying the prescription label with the machine readable code to a prescription medication container having the medication associated with the prescription. The method further includes sorting the prescription medication containers, having prescription labels with the machine readable code, according to the healthcare facility having ordered the prescriptions in preparation of shipping the prescription medication containers to the healthcare facilities. The method further includes providing a database including data relative to a prescription number and for each prescription number there is data relative to the name of the patient, name of the healthcare facility where the patient is located, the date the prescription was previously filled and the date the prescription was previously shipped from the pharmacy to the healthcare facility. The method further includes reading the machine readable code on the prescription labels, from one or more computers equipped with one or more first readers at the pharmacy, to verify that all the prescriptions ordered from a healthcare facility during a predetermined time duration have been properly sorted according to respective healthcare facilities. The method further includes updating the database including updating the data relative to the date the prescription was shipped to a corresponding healthcare facility. The method further includes reading the machine readable code on the prescription labels, from one or more computers equipped with one or more second readers at the healthcare, to verify that all the prescriptions ordered from a healthcare facility during the predetermined time duration have been have been received at the healthcare facility. The method further includes updating the database including updating the data relative to the date the prescription was received at the respective healthcare facility.

In another embodiment of the present invention, a container is provided for holding prescription medication. The container includes a plurality of compartments, where each compartment holds the prescription medication. The container also includes a backing surface to enclose each of the compartments, where the backing surface extends from a first edge to a second edge along the container. The container also includes a prescription label generated with a machine readable code of prescription data related to the prescription medication. The prescription label is positioned on the container and spaced from the backing surface by at least a minimum separation from the second edge.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not, therefore, to be considered to be limiting of its scope, the embodiments of the invention will be described and explained with additional specificity and detail through the use of the accompanying drawings in which:

FIG. 1 is a partial schematic block diagram of a system for tracking and dispensing of medication relating to prescriptions from a pharmacy to multiple healthcare facilities in accordance with an exemplary embodiment of the present invention;

FIG. 2 is a partial schematic block diagram of a system for tracking and dispensing of medication relating to prescriptions from a pharmacy to multiple healthcare facilities in accordance with an exemplary embodiment of the present invention;

FIG. 3A is a plan view of a prescription label with a machine readable code for use in the system depicted in FIGS. 1 and 2;

FIG. 3B is a plan view of a medication container with an RFD tag with a metallic backing spaced from the RFID tag;

FIG. 4 is a plan view of a bin for sorting medication containers used within the system depicted in FIGS. 1 and 2;

FIG. 5 is a prescription data file used within the system depicted in FIGS. 1 and 2;

FIG. 6 is a verification table used within the system depicted in FIGS. 1 and 2;

FIG. 7 is a flow chart illustrating an exemplary embodiment of a method for tracking and dispensing of medication relating to prescriptions from a pharmacy to multiple healthcare facilities;

FIG. 8 is a schematic illustration of a check or verification station including multiple readers and a computer for verifying if prescription medications have been properly sorted for shipment or received at a healthcare facility; and

FIG. 9 is a schematic illustration of an inventory station where an inventory reader is used to perform an inventory check of prescription medication at a healthcare facility.

FIG. 10 is a flow chart illustrating an embodiment of a method for tracking and dispensing of medication relating to prescriptions including the return of prescriptions from the healthcare facilities to the pharmacy.

FIG. 11 is a verification table that may be displayed on a computer monitor regarding the return of prescriptions from the healthcare facilities to the pharmacy.

FIG. 12 is a verification table that may be displayed on a computer monitor regarding confirmation of the return of prescriptions from the healthcare facilities to the pharmacy.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

The embodiments of the present invention discuss the processing of orders for prescription medication, which are initiated from a healthcare facility housing patients, and transmitted to a pharmacy, which processes the prescription medication orders, and subsequently ships the prescription medication to the healthcare facility. The healthcare facility may be any of a number of facilities which houses and treats patients, such as a hospital, nursing home, assisted living facility, or any similar facility. The pharmacy may be a remote facility to the healthcare facility which is primarily concerned with ensuring that the prescription orders placed by the healthcare facilities are accurately filled, are shipped to the healthcare facility and are received at the healthcare facility. Alternatively, the pharmacy need not be positioned remotely from the healthcare facility. In addition to the healthcare facilities and the pharmacy, a remote facility may include a database which is in communication with the healthcare facilities and the pharmacy. The database is continuously updated with information regarding the prescription medication orders to each healthcare facility, at each stage of the process of fulfilling the order request. Additionally, the database may be used by the healthcare facility, to perform an inventory of the prescription medication on-site at the healthcare facility, as discussed in greater detail below.

### Ordering and Filling Prescriptions:

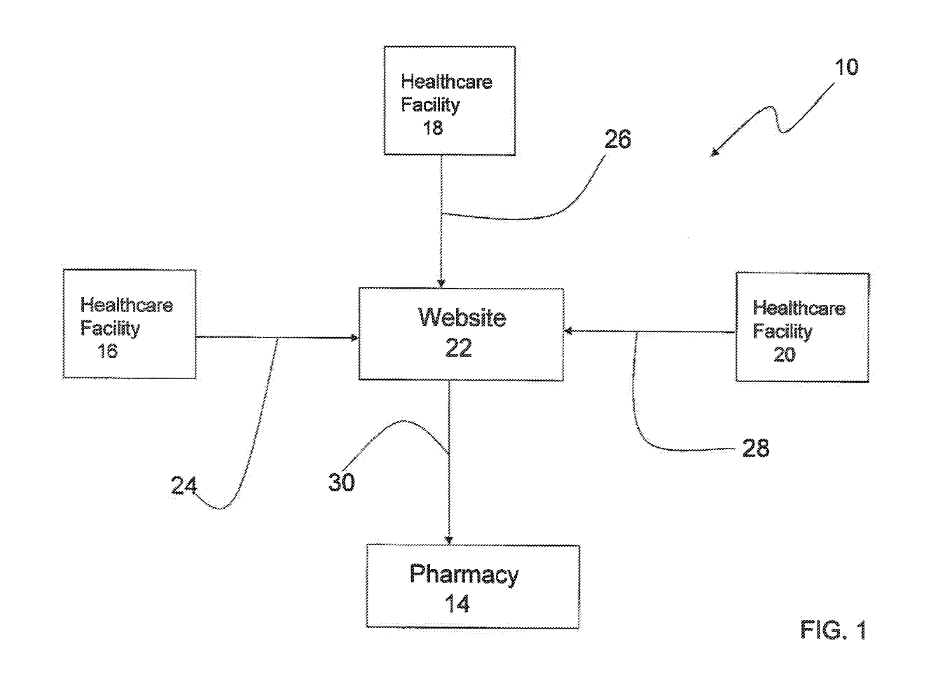

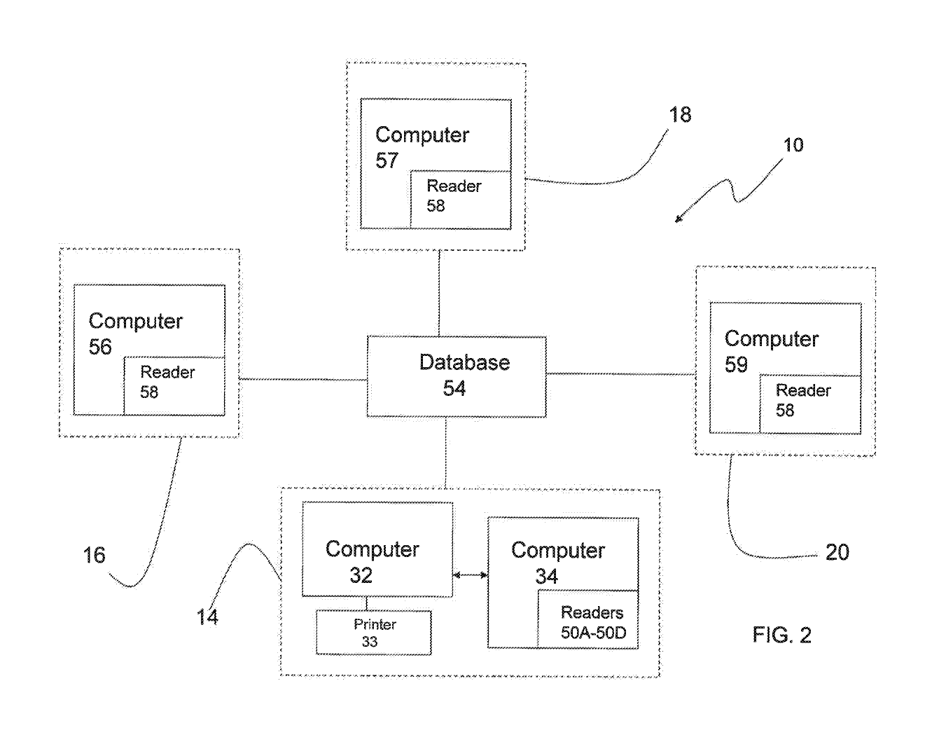

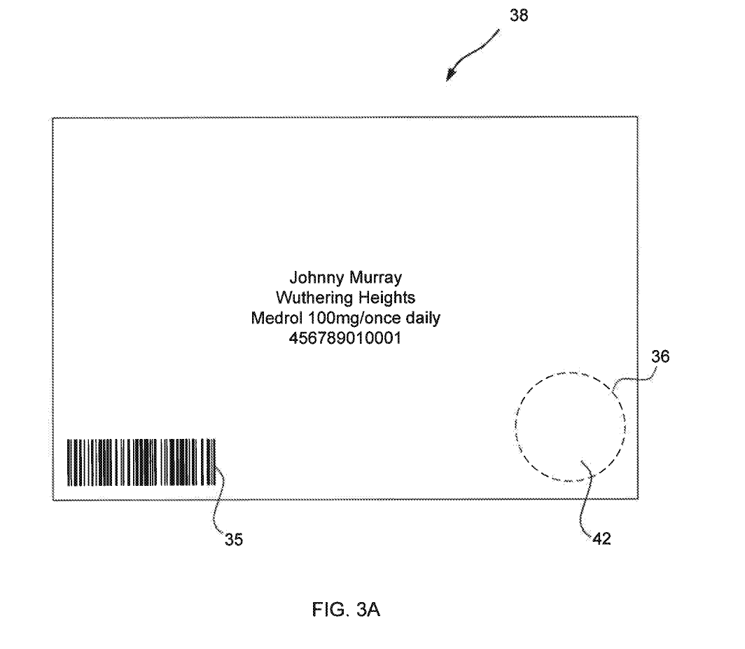

FIGS. 1 and 2 illustrate components of a system 10 for tracking and dispensing of medication 12 (FIG. 3B) relating to prescriptions from a pharmacy 14 to multiple healthcare facilities 16,18,20. Although FIG. 1 illustrates three healthcare facilities 16,18,20, the embodiments of the present invention are not limited to three healthcare facilities and may include less or more than three healthcare facilities. As illustrated in FIG. 1, the system 10 includes a secure website 22 and a data communication link 24,26,28 between each of the healthcare facilities 16,18,20 and the website 22. Additionally, the system 10 includes a data communication link 30 between the pharmacy 14 and the website 22. When a prescription order is requested, prescription data is inputted by a worker at the healthcare facility 16, which is subsequently communicated to the website 22 via the communication link 24 and subsequently transferred to the pharmacy 14 via the communication link 30. The inputted prescription data may include such parameters as the patient's name, the healthcare facility, an identification of the medication or prescription drug, and a medication dosage of the prescription. The medication dosage is defined as a prescribed amount of a medication or drug to be given to a patient for some predetermined time duration. Once the pharmacy 14 receives the inputted prescription data over the communication link 30, software associated with a computer 32 (FIG. 2) at the pharmacy 14 and/or the website 22 assigns a prescription number to each order. A known software product that is used in connection with ordering via a secure website is provided by QS1®, which is headquartered in Spartanburg, S.C.

In an exemplary embodiment, the assigned prescription number may be a 12-digit number such as 123456780001, in which the first eight digits are encoded on a prescription label 36 (FIGS. 3A and 3B) on a medication container 38 (FIGS. 3A and 3B), while the last four digits indicate the number of refills of that prescription. For example, prescription number 123456780001 would change to 123456780002 when that prescription order is filled for the second time. However, the inputted prescription order need not include all of the above inputted data parameters nor have a 12-digit prescription number, and may include less or more of these data parameters, for example. As discussed in greater detail below, at periodic stages, the pharmacy 14 may download all inputted prescription data for all inputted orders over a predetermined time period from all healthcare facilities 16,18,20. For example, at 5 pm EST each day, the pharmacy 14 may download all prescription data for all inputted orders filled on that particular business day from all healthcare facilities 16,18,20. Thus, the predetermined time period, in this example, is the length of the pharmacy's business day.

After downloading the prescription data over the communication link 30 for all inputted orders for the predetermined time period for the respective healthcare facilities 16,18,20, the computer 32 generates labels 36 (FIGS. 3A and 3B) for medication containers 38 to hold each prescription order. The computer 32 is connected to a printer 33 that prints alphanumeric symbols, representing the prescription data, on a print medium to create labels 36. The print medium may have data storage/transmission devices at spaced intervals. When print commands are sent to the printer 33, the prescription data or a portion thereof is printed on the label 36 and for each prescription number, the prescription data is encoded or stored as machine readable code 42 on the RFID label 36. In addition, or alternatively, the prescription data may be available on the prescription label 36 as machine readable code in the form of a barcode 43. The computer 32 generates each label 36 in response to each inputted order received from each healthcare facility 16,18,20. As illustrated in FIGS. 3A and 3B, the labels 36 are generated with a machine readable code 42 of the prescription data including the prescription number, the patient's name, the healthcare facility, an identification of a drug prescribed, and the medication dosage. However, the machine readable code 42 may include less or more than the above-listed data elements. In an exemplary embodiment, the label 36 may be an REID (Radio Frequency Identification tags) tag and/or may include a bar code 43 with the same data.

As illustrated in FIGS. 3A and 3B, once the prescriptions are ordered they are filled and prescription labels 36 are printed and applied to a container 38. In an exemplary embodiment, the container 38 is a blister pack with individual compartments 39 to hold the prescribed medication. As further illustrated in FIG. 3B, an inner surface 41 of the container 38 reveals a backing surface 43 of the compartments 39 which extends from a first edge 45 adjacent to a base of the container 38 to a second edge 47 to provide a backing for each of the compartments 39 to enclose each of the compartments 39, when the container 38 is folded closed. In an exemplary embodiment, the backing surface 43 may be made from a metallic material, such as aluminum, for example. In another exemplary embodiment, the label 36 is positioned on the container 38 at a minimum distance 49 above the edge 47, and thus the metallic backing surface 43 does not extend within the minimum distance 49 of the label 36, to minimize any interference between the readers 50,58, the RFID label 36 of the system 10 and the metallic material of the backing surface 43. Accordingly, the edge 47 is spaced by the minimum distance 49 from the RFID label 36 to avoid such data communication interference. In the exemplary embodiment shown in FIG. 3B, the width of the container 38 is 6 inches, the length of the container 38 is 8.75 inches, the backing surface 43 extends 7 inches from the first edge 45 to the second edge 47 and the minimum distance 49 is approximately 0.5 inches from the second edge 47 to the RFID label 36. The second edge 47 is positioned such that the backing surface 43 provides a backing for each of the compartments 39 of the container 38, and that the minimum distance 49 between the second edge 47 and the label 36 is sufficient to avoid any noticeable interference that would hinder the reader 50,58 scanning of the label 36. In an exemplary embodiment, the minimum distance may be 0.75 inches, 1 inch or 1.25 inches, for example. Although specific numeric dimensions for the minimum distance 49 are discussed herein, one of skill in the art will appreciate that the minimum distance may be determined based on the dimensions of the container 38, such that the metallic material of the backing surface does not provide noticeable interference for a reader when scanning the label.

### Sorting and Verifying Prescriptions for Shipment:

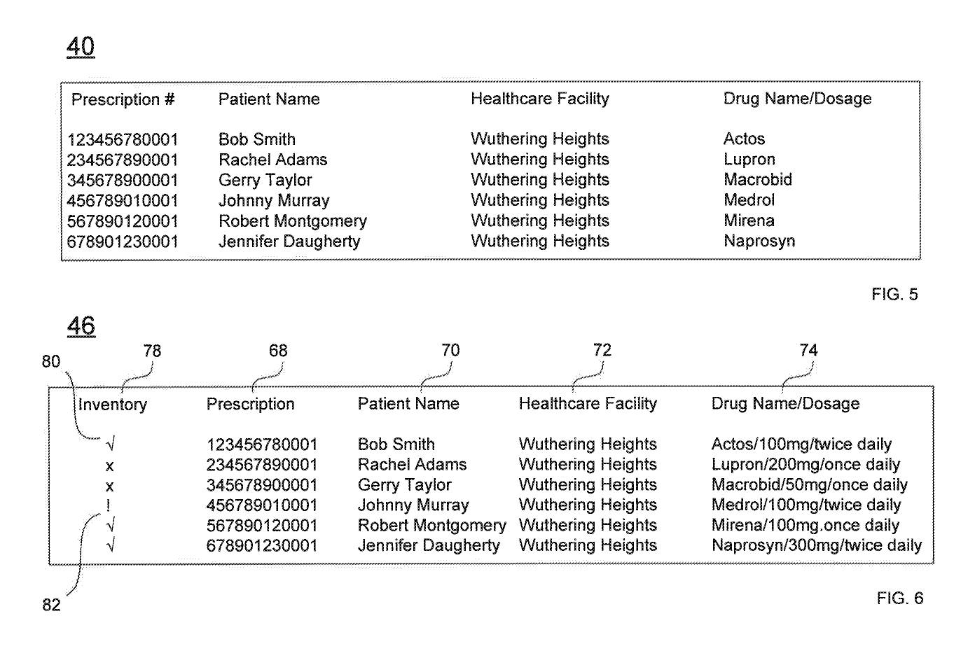

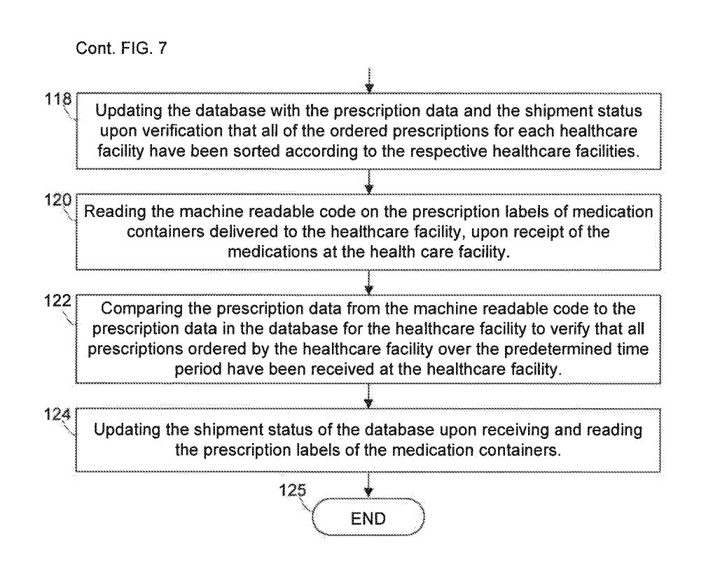

After the containers 38 are filled and the prescription labels 36 with the machine readable code 42 are applied to the container 38, they are taken to a shipping area. A software program is provided that is configured to access the prescription data generated when prescriptions are ordered. Thus, during the course of the predetermined time period when prescriptions are ordered, the software is configured to store or download the prescription data into an accessible data file 40 (FIG. 6). As further illustrated in FIG. 2, the pharmacy 14 includes a second computer 34 to generate a verification table 46 (FIG. 6) using the data from the prescription data file 40 based on all inputted orders over the predetermined time period for each healthcare facility 16,18,20. As illustrated in FIG. 6, the verification table 46 is based on the downloaded prescription data file 40, but further includes an inventory column 78 for each inputted order, to indicate whether each prescription order is ready for shipment from the pharmacy 14, as discussed in greater detail below. As illustrated in FIG. 6, the verification table 46 includes a plurality of columns to include the data from the prescription data file 40 including a prescription number column 68, a patient name column 70, a healthcare facility column 72 and a drug/dosage identification column 74, As illustrated in the verification table 46 of FIG. 6, the data from the prescription data file 40 is sorted based on healthcare facility such that prescription orders with the same healthcare facility in the column 72 are listed together. Although FIG. 2 illustrates a first and second computer 32,34 at the pharmacy 14, the pharmacy need only include one computer to generate the verification table 46 and perform the other tasks assigned to the second computer. The verification table 46 may be displayed on the second computer 34 monitor 37 (FIG. 8) and includes the data from the prescription data file 40, sorted by each healthcare facility 16,18,20. Thus, for example, the verification table 46 would list all of the inputted orders from the healthcare facility 16, separate from listing the inputted orders from the healthcare facility 18.

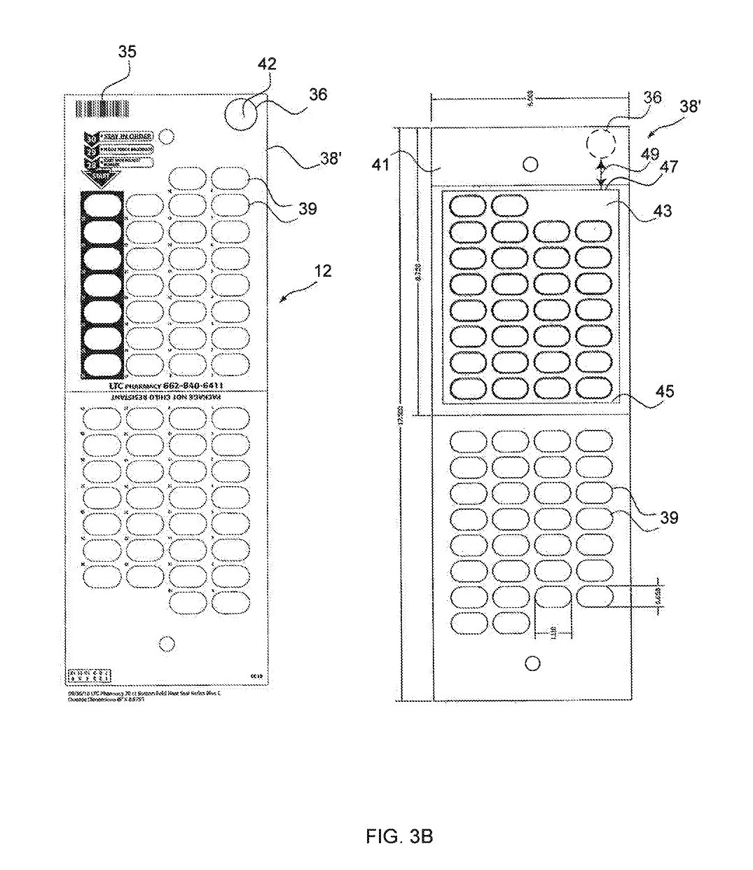

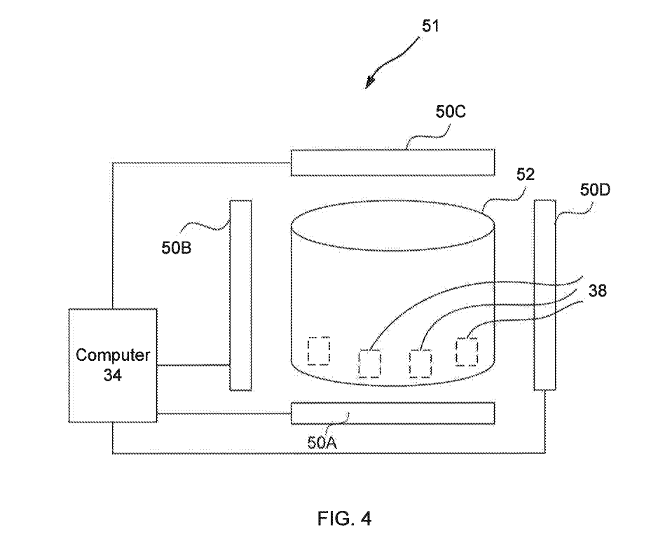

As further illustrated in FIG. 2, the system 10 includes readers 50A-50D that are linked to the second computer 34 at the pharmacy 14. In an exemplary embodiment, the readers 50A-50D may be MID readers. After the prescription labels 36 are generated, they are placed on each medication container 38 after the medication containers 38 are tilled with the necessary medication. The medication containers 38 are then sorted into a bin 52 (FIGS. 4, 8) based on the destination healthcare facility 16,18,20. Thus, for example, all of the medication containers 38 for inputted orders placed within the predetermined time for the first healthcare facility 16 are placed in a first bin, while all medication containers 38 for inputted orders placed within the predetermined time for the second healthcare facility 18 are placed in a second bin. The readers 50A-50D are then used to scan the machine readable code 42 on the prescription labels 36 for each bin 52 (and healthcare facility 16,18,20).

As shown in FIG. 8, the bin 52 is positioned on a surface 63 of a cart 61 and the readers 50A-50D may be a component of a station 51 and are mounted proximate to the cart 61, and more specifically, are mounted to respective surfaces 63,65,67,69 of the cart 61, which surround the bin 52 positioned on the cart surface 63. The bin 52 holds medication containers 38 for a respective healthcare facility 16, 18 or 20. A monitor 37 associated with the second computer 34 is prompted to display the verification table 46 for a healthcare facility 16, 18 or 20 associated with the medication containers 38 in bin 52. When prompted by the computer 34, the readers 50A-50D are able to automatically read or scan all of the machine readable code 42 on RFID labels 36 within the bin 52 without having to manually read each RFID label 36 individually. The second computer 34 includes software to compare the data received from the machine readable code 42 to the data as represented in the verification table 46 for the respective healthcare facility 16,18,20, to verify that all of the ordered prescriptions for the respective healthcare facility 16,18,20 have been filled and sorted for delivery in the respective bin 52.

Again in reference to FIG. 6, the column 78 of the verification table 48 includes symbols indicating whether a prescription associated with a respective healthcare facility 16, 18 or 20 has been read by the readers 50A-50B. For example, before the machine readable codes 42 in the bin 52 have been read, all the prescriptions will have an “X” symbol, indicating that no prescription data has been read. As illustrated in FIG. 6, as the readers 50A-50D scan the machine readable code 42 of a prescription that corresponds to the prescription data in the verification table 46, an indicator 80, such as a check mark, for example, is placed in the inventory column 78 for the respective prescription order. After the first readers 50A-50D have read the machine readable code 42 on all the prescription labels 36 in the bin 52, a worker may review the verification table 46 to see if any “X” remain in column 78 to see if any prescriptions associated with the respective healthcare facility 16, 18 or 20 are missing. In addition, if the first readers 50A-50D scans the machine readable code 42 of a prescription which does not correspond to prescription data in the verification table 46, an audible or visual alert warning may be outputted through the monitor 37 of the second computer 34. In either scenario, a worker may take appropriate actions to correct the error at that time.

After all of the prescriptions have been “checked in”, the prescription data from the verification table 46 is uploaded to a database 54. It should be noted that the prescription data includes an identifying parameter of the individual operating the reader, as the individual may be required to log in to the computer 34 prior to operating the computer 34 and the readers 50A-50D. In addition, the prescription data uploaded to the database 54 may include the date and time the prescriptions were verified for shipment. If errors in sorting of the prescriptions remain, the computer 34 will issue an alert indicator 82 indicating in the verification table 46 that the prescription order has not been properly sorted for delivery. The computer 34 and/or software may be configured to deny the upload until all errors are corrected. Once the computer 34 verifies that all medication containers 38 for a respective healthcare facility 16,18,20 in the bin 52 are scanned the database 54 is updated accordingly. Although FIGS. 4 and 8 illustrate four readers 50A-50D being used to scan the machine readable code 42 at the station, less or more than four readers may be used, provided that the readers are capable of reading the machine readable code from the labels are transmitting the data to the second computer.

As illustrated in FIG. 2, the database 54 may be positioned at a remote location from the pharmacy 14 and the healthcare facilities 16,18,20, and includes data relative to each healthcare facility 16,18,20 including the name and location of the healthcare facility, and the name of each patient registered to each healthcare facility 16,18,20. When a healthcare facility joins the system 10, it uploads its identifying information (i.e., address, etc) and patient information to the database 54. Each of the healthcare facilities 16,18,20 regularly updates the database with patient information on a periodic basis, as the patient population changes. Additionally, the database 54 includes information pertaining to the medication information associated with each patient including the type and dosage for the medication, and a shipment status of the inputted prescriptions. As noted above, after the second computer 34 at the pharmacy 14 verifies that all of the ordered prescriptions for the respective healthcare facility 16,18,20 have been filled and sorted for delivery by marking the inventory column 78, the verification table 46 is uploaded to the database 54 from the second computer 34 and the shipment status of the inputted orders is uploaded to the database 54 upon verification that all of the ordered prescriptions for each healthcare facility 16,18,20 are sorted and shipped. In an exemplary embodiment, the second computer 34 updates the database 54 with the shipment status which may include a date and/or time of shipment of the medication containers 38 from the pharmacy and an identity of a shipping entity of the prescriptions to the healthcare facility 16,18,20. For example, the shipment status may provide a date, time and tracking number for a shipping service, such as UPS®, for example.

### Shipments Received at Healthcare Facility:

As further illustrated in FIG. 2, a third computer 56,57,59 is provided at each of the healthcare facilities 16,18,20 and a second reader 58 is linked to the third computer 56,57,59. The third computer 56,57,59 accesses the database 54 to download the verification table 46 of the prescription data previously uploaded by the second computer 34 of the pharmacy 14. The verification table 46 may be displayed on the third computer monitor (not shown), and the second reader 58 scans the machine readable code 42 on the prescription labels 36 of the medication containers 38 that are delivered to the healthcare facility 16,18,20. The healthcare facilities 16, 18 and 20 may have a station similar to that shown in FIG. 8 containing multiple readers 58 to avoid the need for one to manually read each individual machine readable code 42 on the prescription labels 36.

The third computer 56,57,59 compares the prescription data from the machine readable code 42 with the prescription data in the verification table 46 for the healthcare facility 16,18,20 to verify that all of the ordered prescriptions by the healthcare facility 16,18,20 over the predetermined time period have been received at the healthcare facility 16,18,20. The third computer 56, 57, 59 subsequently updates the shipment status of the database 54 upon receiving and reading the labels 36 of the containers 38. In an exemplary embodiment, the third computer 56,57,59 updates the database 54 with the shipment status which may include a date and/or time of delivery to the healthcare facility 16,18,20 and an identity of a receiving entity at the healthcare facility of the prescriptions, to provide some level of human accountability, in the event that the prescription medication is lost or stolen after delivery. For example, if an individual named Bob Smith receives the shipment of prescriptions at the healthcare facilities 16 on Dec. 16, 2010, the third computer 56 updates the database 54 with a delivery date of Dec. 16, 2010, and that Bob Smith was the receiving entity at the healthcare facility 16.

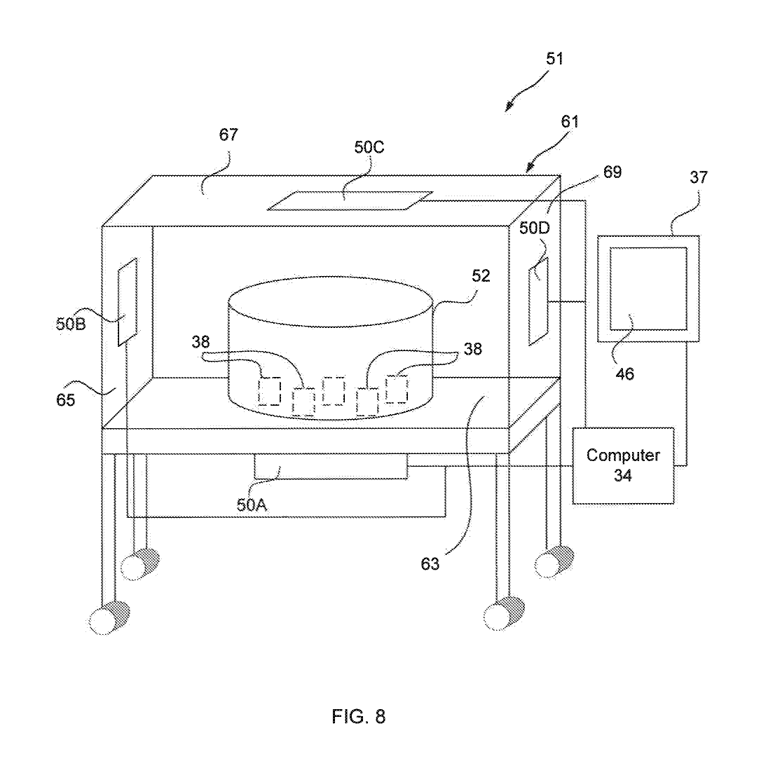

In addition to the medication container 38 having a label 36 with a machine readable code, each worker and patient at the healthcare facility may be respectively provided with a label with a machine readable code. When the healthcare worker administers medication from the medication container 38 to a patient, the healthcare worker 73 may carry a mobile handheld reader 71 (FIG. 9) which scans three labels before administering the medication: (1) the machine readable code 42 of the medication container 38, (2) the machine readable code of the patient and (3) the machine readable code of the healthcare worker. The healthcare worker inputs into the reader that the patient has ingested the medication, after which the reader (in communication with the computer 56,57,59) transmits a signal to the computer 56,57,59 to update the prescription data for the respective patient, including to indicate which specific dosage was administered by which healthcare worker. The computer 56,57,59 subsequently updates the database 54, either automatically or at a regular timed interval, with this updated prescription data.

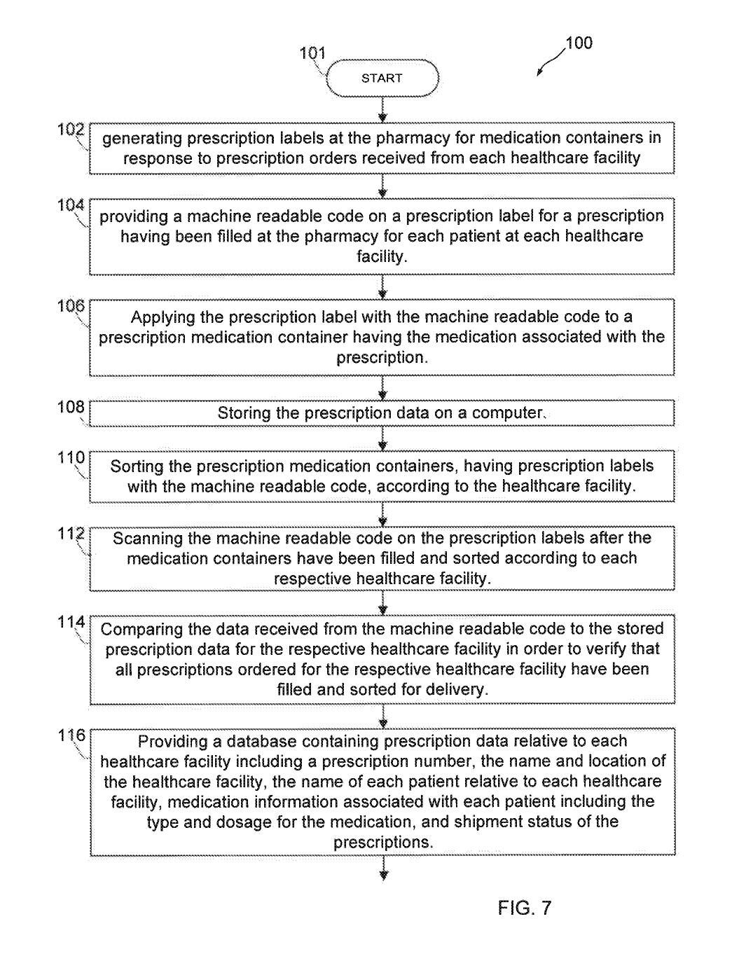

FIG. 7 illustrates a flow chart depicting an exemplary embodiment of a method 100 for tracking and dispensing of medication relating to prescriptions from the pharmacy 14 to multiple healthcare facilities 16,18,20. The method 100 starts at 101 by generating 102 prescription labels 36 at the pharmacy 14 for medication containers 38 in response to prescription orders received from each healthcare facility 16,18,20. The labels 36 having a machine readable code 42 for prescription data including a prescription number, a patient's name, the healthcare facility, an identification of a drug prescribed, and a medication dosage. The method 100 also includes providing 104 a machine readable code 42 on a prescription label 36 for a prescription having been filled at the pharmacy 14 for each patient at each healthcare facility 16,18,20. The machine readable code 42 includes data relative to a prescription number and for each prescription number there is data relative to the name of the patient, name of the healthcare facility where the patient is located, identification and dosage of a medication associated with the prescription and the date the prescription was filled. The method 100 also includes applying 106 the prescription label 36 with the machine readable code 42 to a prescription medication container 38 having the medication associated with the prescription. The method 100 further includes storing 108 the prescription data on a computer 32. The method 100 also includes sorting 110 the prescription medication containers 38, having prescription labels 36 with the machine readable code 42, according to the healthcare facility 16,18,20 having ordered the prescriptions in preparation of shipping the prescription medication containers to the healthcare facilities. The method 100 further includes scanning 112 the machine readable code 42 on the prescription labels 36 after the medication containers 38 have been filled and sorted according to each respective healthcare facility 16,18,20. The method 100 further includes comparing 114 the data received from the machine readable code to the stored prescription data for the respective healthcare facility 16,18,20 in order to verify that all prescriptions ordered for the respective healthcare facility 16,18,20 have been filled and sorted for delivery. The method 100 further includes providing 116 a database 54 containing prescription data relative to each healthcare facility 16,18,20 including a prescription number, the name and location of the healthcare facility, the name of each patient relative to each healthcare facility, medication information associated with each patient including the type and dosage for the medication, and a shipment status of the prescriptions. The method 100 further includes updating 118 the database with the prescription data and the shipment status upon verification that all of the ordered prescriptions for each healthcare facility 16,18,20 have been sorted according to the respective healthcare facilities. Upon receipt of the medications at a healthcare facility 16,18,20, the method 100 further includes reading 120 the machine readable code 42 on the prescription labels 36 of medication containers 38 delivered to the healthcare facility 16,18,20. The method 100 further includes comparing 122 the prescription data from the machine readable code 42 to the prescription data in the database 54 for the healthcare facility 16,18,20, to verify that all prescriptions ordered by the healthcare facility over the predetermined time period have been received at the healthcare facility. The method 100 further includes updating 124 the shipment status of the database 54 upon receiving and reading the prescription labels 36 of the medication containers 38, before ending at 125.

### Inventorying:

Embodiments of the present invention may include steps or mechanisms to inventory filled prescriptions at the healthcare facility to assess at least 1) whether all medications that should be present at the healthcare facility are present; and, 2) that medications that should have been exhausted are no longer present at the facility. With respect to the former, a medication that is found missing may indicate that the medication has been stolen or was improperly dispensed to a patient, among other explanations. With respect to the latter, if a medication is found present when it should have been exhausted, this may also indicate that the medication was improperly dispensed to a patient.

By way of example, each healthcare facility orders prescriptions and prescriptions are filled according to a prescription time cycle, such as a twenty-eight day cycle. As previously discussed, the prescription number for each prescription order may include a portion of numbers to track the number of refills of the prescription order, such as an incremental four digit number at the end of a eight digit prescription number, for example. In an exemplary embodiment, the refill portion of the prescription number will also be incremented with each successive twenty-eight day cycle, since each successive twenty-eight day cycle necessarily involves a successive refill of the prescription medication. Each healthcare facility orders prescriptions toward an end such as a prescription time cycle. The pharmacy 14 fills the prescription to provide the appropriate dosage over the 28 day prescription time cycle. When a prescription is ordered a first time, the pharmacy automatically fills the prescription for the following prescription time cycle, unless the pharmacy is instructed to discontinue the prescription. If a healthcare facility needs to order a prescription midway through a prescription time cycle, for example, if it is 14 days into a twenty-eight day cycle, the pharmacy provides sufficient medication to complete the current prescription time cycle. Accordingly, the pharmacy will automatically fill the same prescription for the following prescription time cycle so the medication lasts the entire cycle. Accordingly, at any time during a prescription time cycle, the healthcare facility should not have a prescription medication in inventory that exceeds the total number of days of the prescription time cycle—twenty-eight days in this example. Although an exemplary twenty-eight day cycle is discussed herein, the prescription time cycle is not limited to this duration and may be any fixed duration. Additionally, the embodiments of the present invention are not limited to prescription orders placed within a time-cycle system, and may be used to track prescription orders placed in a non-time cycle system, by comparing a (adjustable) duration of the prescription order with the number of days since a delivery date, to determine whether or not the prescription medication should be at the healthcare facility.

According to an embodiment of the present invention, this prescription time cycle may be used to provide parameter input when inventorying medications at a healthcare facility. As illustrated in FIG. 9, the system 10 may include an inventory station 55 with a mobile handheld reader 71 equipped with an RFID reader for reading the machine readable codes 42 of all medications in inventory at a healthcare facility 16, 18 or 20. For purposes of the discussion below, an inventory of prescription medication at a first healthcare facility 16 will be discussed. However, the same techniques will be employed for performing an inventory at either of the remaining healthcare facilities 18,20. All of the medication containers 38 at the healthcare facility 16 are collected into an inventory bin 53, after which a worker 73 at the healthcare facility 16 scans each RFID label 36 of the containers 38 with the mobile handheld reader 71. In addition to scanning the labels 36 of the containers 38 upon their arrival at the healthcare facility 16, the third computer 56 may be utilized to perform an inventory of the prescription medication at the healthcare facility 16. A first type of inventory which may be performed by the third computer 56 is an inventory to determine whether all medications that should be present at the healthcare facility 16 are present. The user 73 at the healthcare facility 16 inputs a time parameter, either on the mobile handheld reader 71 or on a keyboard of the third computer 56, associated with the current prescription time cycle, such as an input of (1) a date and whether the inventory is to be taken within or outside that date, such as an input of “read only tags within Jan. 20, 2011,” or (2) a number of days relative to the prescription time cycle, such as “read only tags that are 28 days old”, for example, into the mobile handheld reader 71, so that an inventory of all prescriptions delivered during the current prescription time cycle is conducted. All prescriptions delivered to the healthcare facility during the current prescription time cycle are positioned in the inventory bin 53. The mobile handheld reader 71 is then used to scan the machine readable code 42 for all of the medication containers 38 in the bin 53. The third computer 56 then downloads the verification table 46 from the database 54 of all of the prescription data of all of the prescriptions delivered to the healthcare facility 16 within the current prescription time cycle. The third computer 56 then compares the prescription data from the verification table 46 with the machine readable code data 42 from the medical containers 38, to determine if all of the prescription medication containers 38 delivered to the healthcare facility 16 during the current prescription time cycle are present at the healthcare facility 16. Based on the inputted time parameter (to the reader 71 or the keyboard of the third computer 56), the user 73 may prompt the third computer 56 to perform the first inventory at any time, such as one week into the prescription time cycle, in order to ensure that all of the prescriptions delivered in the first week of the prescription time cycle are still present at the healthcare facility 16. For example, if the prescription time cycle began on December 1, the user may input “only inventory tags that are 14 days old”, and the third computer will subsequently determine whether all of the prescriptions delivered to the healthcare facility in the first fourteen days of the prescription time cycle are still present at the healthcare facility. For purposes of performing the inventory, the mobile handheld reader 71 may be a handheld inventory reader, such as a Motorola® MC3090z, for example.

In addition to the first type of inventory above, which determines whether all of the prescription medication that should be present at the healthcare facility 16 is present, a second type of inventory may be performed to verify that medications that should have been exhausted are no longer at the healthcare facility 16. The user 73 inputs into the mobile handheld reader 71 or into the keyboard of the third computer 56, a time parameter outside of the current prescription time cycle, such as “only inventory tags that are 30 days old”, for a twenty-eight day prescription time cycle, for example. As with the first type of inventory above, all of the prescription medication at the healthcare facility 16 is collected into the inventory bin 53. The mobile inventory reader 71 is subsequently used to scan the machine readable code 42 of each medication container 38. The third computer 56 then downloads a verification table 46 from the database 54 of all of the prescription data of all of the prescriptions delivered to the healthcare facility 16 within the current prescription time cycle. The third computer 56 then compares the prescription data from the verification table 46 with the machine readable code data 42 from the medical containers 38. The third computer 56 determines if any of the scanned machine readable code 42 on a medical container 38 is not listed in the prescription data of the verification table 46, as any such machine readable code 42 on the medical container 38 was delivered outside the prescription time cycle and thus should not be present at the healthcare facility 16. If any such machine readable code 42 on a medical container 38 is scanned, the third computer 56 outputs an audible and/or visual alert signal to its display 75 so that the user 73 is informed that the indicated prescription order on the display 75 should have been exhausted/depleted.

In an exemplary embodiment, a prescription order may be placed which has a duration that is less (or more) than the prescription time cycle. For example, a prescription order may be placed at the healthcare facility 16 for a narcotic or an antibiotic medication for a 10-day duration, which is less than a 28-day prescription time cycle for the healthcare facility 16. If a user places a prescription order for a medication with a duration that is not equal to the prescription time-cycle, the user may be prompted to enter the duration of the prescription, which is included in the prescription order data and in the verification table 46. When an inventory is performed of the medication at the healthcare facility 16, all of the medication containers 38 are collected in the inventory bin 53, including those containers 38 of prescription medications with a duration that is not equal to the prescription time cycle. After the user 73 scans the machine readable code 42 of the medication containers 38 for those prescription orders with a duration that is not equal to the prescription time cycle, the third computer 56 downloads a verification table 46 of the prescription data, including the inputted prescription duration and a delivery date. The third computer 56 then compares the prescription duration with the number of days since the delivery date. If the prescription duration is greater than the number of days since the delivery date, the third computer 56 confirms that the prescription medication should be present at the healthcare facility 16. If the prescription duration is less than the number of days since the delivery date, the third computer 56 determines that the prescription medication should have been depleted, and outputs an audible and/or visual alert signal to its display 75 so that the user 73 is informed that the indicated prescription order on the display 75 should have been depleted.

Oftentimes healthcare facilities have to return prescriptions to the pharmacy for a variety of reasons. For example, patients may die; patients may transfer to another facility; or, patients may return to their home. In addition, for certain medications, the healthcare facilities are given a determined amount of the medications, and for patients that leave a facility for whatever reason, those medications must remain with the healthcare facility. Another example is that a prescription for a patient may be changed. That is the dosage may be increased or decreased, and the previously prescribed dosage and medication must be returned to the pharmacy.

In any of these examples, which are not intended to limit the invention, the healthcare facility must return the medications to the pharmacy. This is typically done by a healthcare facility employee, such as an attending nurse, who manually pulls the medication and logs the amount of medication that is being returned and the date the medication is dropped in a receptacle at the facility. The receptacle is checked periodically by the pharmacy for pick-up and return of the medications to the pharmacy. At the pharmacy, the returned medications are logged-in including the amount and date of return. With respect to controlled substances, as identified by the federal Drug Enforcement Agency, the medications are destroyed.

The above-described procedures can be very time consuming and don't provide an automated system for further tracking the status of prescriptions that must be returned to a pharmacy. Accordingly, an embodiment of the above-described systems and methods for managing the tracking and dispensing of medications include software or computer readable media and components that enable and automate the tracking of medications and/or prescriptions that have been otherwise been properly delivered to a healthcare facility; however, the above-described patient status and prescription dosage has changed requiring the return of unused medications and/or prescriptions.

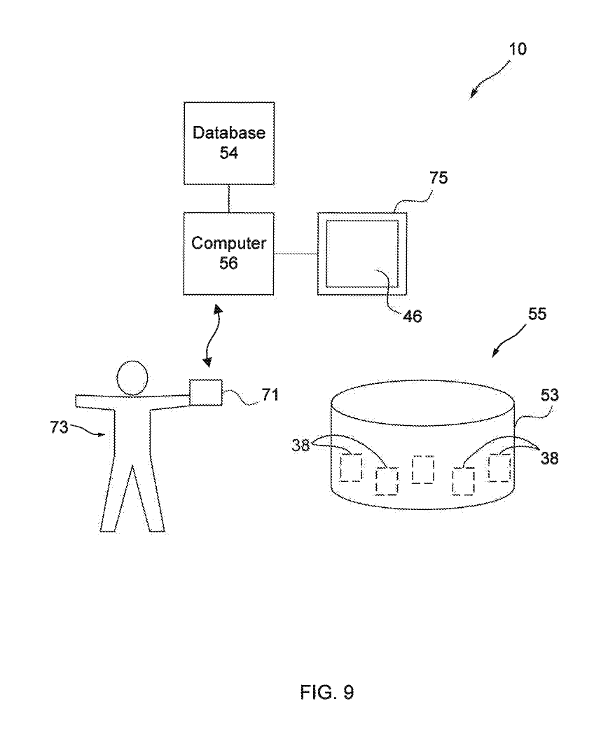

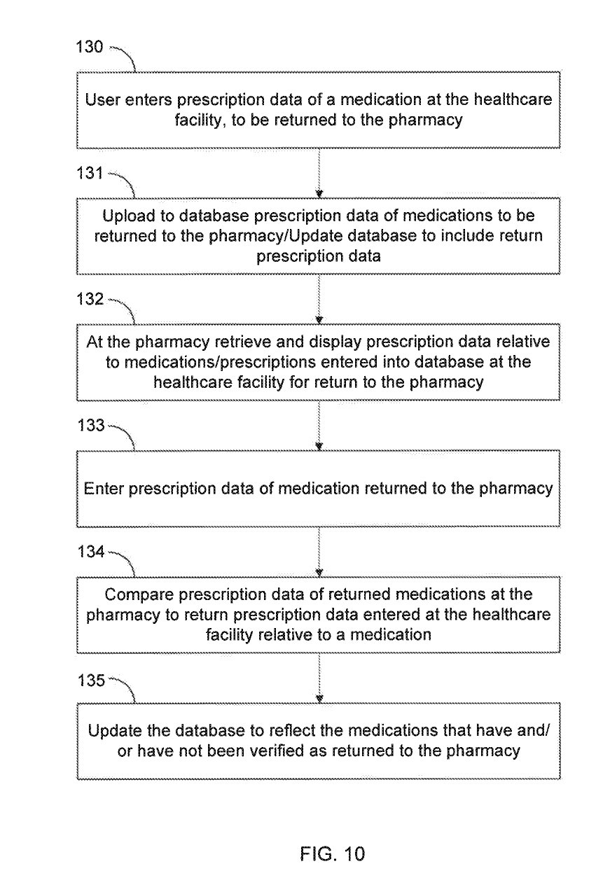

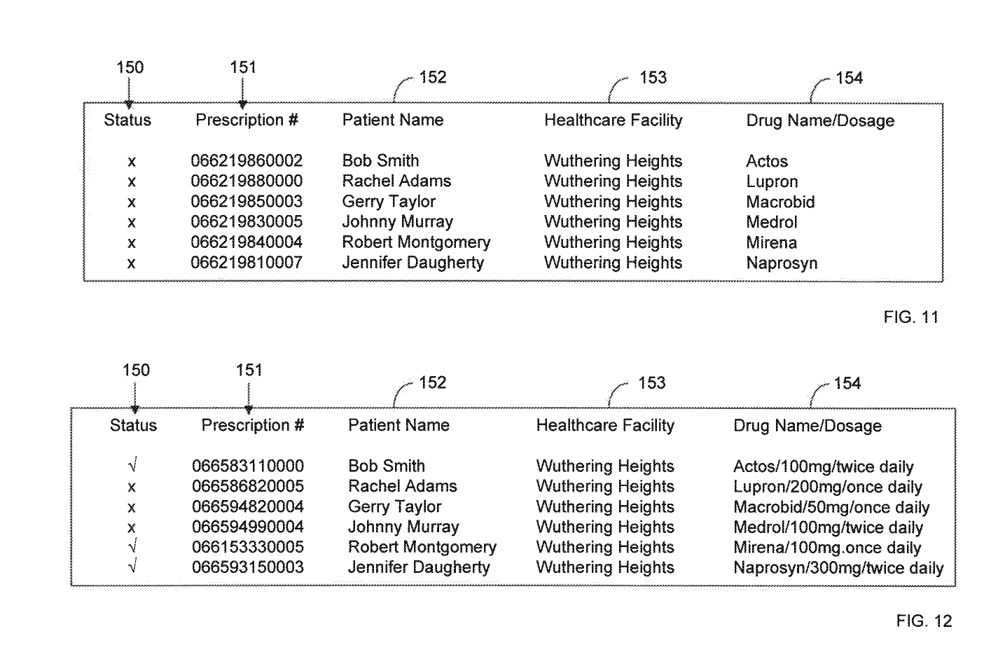

A method and system for tracking the prescriptions returned from a healthcare facility to a pharmacy is described in reference to the flowchart of FIG. 10, representative computer screenshots of FIGS. 11 and 12, and schematic illustrations of FIGS. 1, 2, 4, 8 and 9. While the steps shown in FIG. 10 are separate and apart from the steps of FIG. 7 and can be so performed, the invention described herein may be a continuation the above-described method, after step 124, in reference to FIG. 7 and the other schematic illustrations.

In reference to FIG. 10, at step 130 a user 73 at a healthcare facility 16, 18, 20, enters prescription data of a medication at the healthcare facility 16, 18, 20 to be returned to the pharmacy 14 into the third computer. Other data entered may include the person entering the prescription data, the date and time of entry of the prescription data, and the amount of medication per prescription that will be returned to the pharmacy. This step may include a person at the healthcare facility 16, 18, 20 gathering medications to be returned to the pharmacy 16, which may be done for any of the above-described reasons. The prescription data may also be entered using the above described mobile hand-held readers 71 shown in FIG. 9.

In an embodiment, the user 73 logs on to the computer 56 which may be connected to the display screen or monitor 75. As known to those skilled, the computer 56 may be configured with software that identifies the user 71 and date and time of functions performed by the user 71, such as entry prescription data relative to medications to be returned. In addition, the screen may for example include touchscreen technology so the user 71 simply touches symbols or icons to select particular software functions or applications to enter data. In this particular embodiment, the screen 75 may include a “RETURNS” icon, prompt or the like to open a communications link between the reader 58, 71 and the computer 56 so prescription data can be entered and stored as prescription return data.

At step 131, the prescription data associated with each medication is uploaded to the database 54. The medication containers 38 are placed into a receptacle or bin and readers 58 may be used to scan the machine readable code on the prescription label to enter the prescription data into the computer 56, 57 and/or 59 at a healthcare facility 16. Alternatively, a user 73 may use a hand-held reader 71 to scan and read machine readable code on the prescription label 36. This prescription data as previously defined includes a prescription number, a patient's name, a healthcare facility name, the medication prescribed and the medication dosage. Other data such as the amount of medication to be returned to the pharmacy, the date and time the prescription data was entered for return, and the person entering that data may be stored in the database 54. Accordingly, at step 131, or possibly in a separate step, the database 54 is updated to include the return prescription data associated with that healthcare facility 16.

The medications to be returned are typically stored in a receptacle and picked by the pharmacy at scheduled dates or times once or more a months, either by a pharmacy employee or other cycle in courier delivers prescriptions to the healthcare facility.

At step 132, the database is accessed at the first or second computer 32, 34 at the pharmacy 14 to retrieve the prescription data (return prescription data) to be returned or that has been returned relative to a healthcare facility 16 in the system. A non-limiting example of a monitor screen shot is illustrated in FIG. 11, which shows in column 150 the status of a medication. In this example, if a healthcare facility 14 has entered medications by prescription number (second column 151) in the database 54 for return to the pharmacy and the receipt of the medications has not been verified that status is represented as an “X”. Prior to accessing the database 54, a user at the first or second computer may select the “RETURNS” option and is prompted to enter the name of the facility and then the screen shot of FIG. 11 is displayed. The display may include, for a given healthcare facility, the prescription number and a status indicator to identify whether or not a medication has been verified as returned. In addition, other information may be displayed including a patient's (column 152), the name of the healthcare facility (column 153) and the drug name and/or dosage (column 154).

At steps 133 and 134, the displayed prescriptions can then be verified as received or identified as not received at the pharmacy by using readers 50A-50D at stations shown for example in FIGS. 4 and 8. More specifically, the prescription data on the prescription label 36 is entered into the first or second computer 32, 34 using scanners 50A-50D. Thus at step 133 the prescription data of the returned is entered and saved as returned prescription data.

The computer 32, 34 includes software or a programmable medium so that the returned prescription data entered at the pharmacy is compared to the returned prescription data displayed on the computer screen at the pharmacy. That is, by way of a non-limiting example, the machine readable code on multiple prescriptions labels can be read from a single bin, and the “X” will change to an indicator, like a checkmark as shown in FIG. 12, for each code read from each prescription label to show that returned prescription and associated medication relative to the selected facility has been returned to the facility. To that end, the pharmacy 14 will be able to view other data such as the person at the healthcare facility that removed the medication, the date of removal and the amount of medication to be returned. This latter piece of data can be verified manually at the pharmacy to verify the amount removed from the pharmacy has not been diverted from the point of removal from the healthcare facility to the pharmacy.

In view of the above, once the prescription data on prescription labels for returned medications, the pharmacy 14 will be able verify or determine that all medications entered for return at the healthcare facility have reached the pharmacy, or identify which medications that were entered for return did not make it to the pharmacy 14. Then at step 135, the database 54 is updated to include data relative to medications that were entered for return to the pharmacy and have been verified as received or not received at the pharmacy. In this manner, the above described systems and methods are able to track medications that have been removed from the healthcare facility 16 for return to the pharmacy 14.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for tracking and dispensing of medication relating to prescriptions from a pharmacy to multiple healthcare facilities, comprising:
a secure website and one or more data communication links between one or more computers at each healthcare facility and the website, and one or more data communication links between one or more computers at the pharmacy and the website, for the transfer of prescription data between the healthcare facilities and the pharmacy wherein prescriptions are ordered from the healthcare facilities via the website;
a first computer at the pharmacy for generating prescription labels for medication containers in response to the prescription data received from each healthcare facility and the labels being generated having thereon machine readable code of the prescription data including a prescription number, a patient's name, the healthcare facility, an identification of a drug prescribed, and a medication dosage;
wherein the first computer, or a second computer in communication with the first computer, generates a verification table of the prescriptions ordered over a predetermined time period for each healthcare facility wherein the verification table is displayed on a first or second computer monitor and includes the prescription data for each healthcare facility received over the predetermined time period;
one or more first readers that are linked to the first computer, or the second computer at the pharmacy, for reading the machine readable code on the prescription labels after the medication containers have been filled and sorted by each respective healthcare facility, and wherein the first or second computer is configured with software to compare the prescription data received from the machine readable code to the prescription data on the verification table for the respective healthcare facility in order to verify that all prescriptions ordered for the respective healthcare facility have been filled and sorted for delivery;
a database containing data relative to each healthcare facility including the name and location of the healthcare facility, the name of each patient relative to each healthcare facility, medication information associated with each patient including the type and dosage of a medication, and a shipment status of the prescriptions, wherein the prescription data of the verification table is uploaded to the database from the first or second computer and the shipment status is uploaded to the database upon verification that all of the ordered prescriptions for each healthcare facility have been properly sorted for shipment; and
a third computer at the healthcare facility and one or more second readers that are linked to the third computer which is configured to access the database to download the prescription data, wherein a second verification table is displayed on a monitor linked to the third computer, and the one or more second readers are configured to read the machine readable code on the prescription labels of medication containers delivered to the healthcare facility, and the third computer is configured to compare the prescription data from the machine readable code with the prescription data in the verification table for the healthcare facility to verify that all prescriptions ordered by the healthcare facility over the predetermined time period have been received at the healthcare facility, the third computer configured to update the shipment status of the database upon receiving and reading the labels of the containers;
wherein the third computer at the healthcare facility is configured wherein upon a command entered at the healthcare facility to receive and store prescription data from the second readers at the healthcare facility and categorize such prescription data as return prescription data relative to each medication and the healthcare facility to be returned to the pharmacy;
wherein the second readers are used to scan and read the machine readable code including the prescription data on the prescription labels of one or more medication containers at the healthcare facility and received from the pharmacy, which containers contain medication to be returned to the pharmacy;
the third computer is further configured to upload the prescription data having been entered for those medications to be returned to the pharmacy to the database which stores the prescription data as return prescription data;
the second computer at the pharmacy is further configured wherein upon a command entered at the pharmacy to receive and store prescription data from the first readers at the pharmacy relative to prescription labels on medication containers that have been returned to the pharmacy; and,
wherein the first or second computer at the pharmacy is further configured to compare the prescription data of the returned medications having been entered to the return prescription data entered at the healthcare facility to verify whether or not the medications returned from the healthcare facility have been received at the pharmacy.

2. The system of claim 1, wherein upon command the first or second computer is configured upon entry of a name of a healthcare facility retrieves data relative to the return prescription data entered at the named healthcare facility and the return prescription data is displayed including a prescription number for each medication having been entered at the named healthcare facility for return to the pharmacy.

3. The system of claim 2, wherein the first or second computer is further configured to display on the screen a list of the prescription numbers for medications having been entered at the named healthcare facility for return to the pharmacy and beside each prescription number an indicator is provided indicating whether or not the medication associated with the prescription number has been verified as received at the pharmacy.

4. The system of claim 4, the first or second computer is further configured to display on the screen an indicator that a medication associated with a prescription number has not been verified as received and to change the indicator to indicate that the medication associated with the prescription has been received if the machine readable code associated with the prescription number is read by one of the readers at the pharmacy.

5. A system for tracking and dispensing of medication relating to prescriptions from a pharmacy to multiple healthcare facilities, comprising:
a secure website and one or more data communication links between one or more computers at each healthcare facility and the website, and one or more data communication links between one or more computers at the pharmacy and the website, for the transfer of prescription data between the healthcare facilities and the pharmacy wherein prescriptions are ordered from the healthcare facilities via the website;
a first computer at the pharmacy for generating prescription labels for medication containers in response to the prescription data received from each healthcare facility and the labels being generated having thereon machine readable code of the prescription data;
wherein a second computer, in communication with the first computer, generates a verification table of the prescriptions ordered for each healthcare facility wherein the verification table is displayed on a monitor of the second computer and includes the prescription data for each healthcare facility;
one or more first readers that are linked to the second computer at the pharmacy, for reading the machine readable code on the prescription labels after the medication containers have been filled and sorted by each respective healthcare facility, and wherein the second computer is configured with software to compare the prescription data received from the machine readable code to the prescription data on the verification table for the respective healthcare facility in order to verify that all prescriptions ordered for the respective healthcare facility have been filled and sorted for delivery;
a database containing data relative to each healthcare facility including the name and location of the healthcare facility, the name of each patient relative to each healthcare facility, medication information associated with each patient including the type and dosage of a medication, and a shipment status of the prescriptions, wherein the prescription data of the verification table is uploaded to the database from the second computer and the shipment status is uploaded to the database upon verification that all of the ordered prescriptions for each healthcare facility have been properly sorted for shipment; and
a third computer at the healthcare facility and one or more second readers that are linked to the third computer which is configured to access the database to download the prescription data, wherein a second verification table is displayed on a monitor linked to the third computer, and the one or more second readers are configured to read the machine readable code on the prescription labels of medication containers delivered to the healthcare facility, and the third computer is configured to compare the prescription data from the machine readable code with the prescription data in the verification table for the healthcare facility to verify that prescriptions ordered by the healthcare facility have been received at the healthcare facility, the third computer configured to update the shipment status of the database upon receiving and reading the labels of the containers;
wherein the third computer at the healthcare facility is configured upon a command entered at the healthcare facility to receive and store prescription data from the second readers at the healthcare facility and categorize such prescription data as return prescription data relative to each medication and the healthcare facility to be returned to the pharmacy;
wherein the second readers are used to scan and read the machine readable code including the prescription data on the prescription labels of one or more medication containers at the healthcare facility and received from the pharmacy, which containers contain medication to be returned to the pharmacy;
the third computer is further configured to upload the prescription data having been entered for those medications to be returned to the pharmacy to the database which stores the prescription data as return prescription data; and,
the second computer at the pharmacy is further configured wherein upon a command entered at the pharmacy to receive and store prescription data from the first readers at the pharmacy relative to prescription labels on one or more medication containers that have been returned to the pharmacy; and,
wherein the second computer at the pharmacy is further configured to compare the prescription data of the returned medications to the return prescription data entered at the healthcare facility to verify whether or not the medications returned from the healthcare facility have been received at the pharmacy.

6. A method for tracking and dispensing of medication relating to prescriptions from a pharmacy to multiple healthcare facilities, comprising:
generating prescription labels with a first computer at the pharmacy for medication containers in response to prescription orders received from each healthcare facility, said labels having a machine readable code for prescription data including a prescription number, a patient's name, the healthcare facility, an identification of a drug prescribed, and a medication dosage;
storing the prescription data on the first computer;
scanning the machine readable code on the prescription labels with a reader of the first computer or a second computer at the pharmacy after the medication containers have been filled and sorted according to each respective healthcare facility;
comparing the data received from the machine readable code to the stored prescription data for the respective healthcare facility with the first or second computer in order to verify that all prescriptions ordered for the respective healthcare facility have been filled and sorted for delivery;
providing a database containing prescription data relative to each healthcare facility including a prescription number, the name and location of the healthcare facility; the name of each patient relative to each healthcare facility, medication information associated with each patient including the type and dosage for the medication, and a shipment status of the prescriptions;
updating the database using the first computer with the prescription data and the shipment status upon verification that all of the ordered prescriptions for each healthcare facility have been sorted according to the respective healthcare facilities;
upon receipt of the medications at a healthcare facility, reading the machine readable code on the prescription labels of medication containers delivered to the healthcare facility with a reader of a third computer at the healthcare facility;
comparing the prescription data from the machine readable code to the prescription data in the database for the healthcare facility with the third computer, to verify that all prescriptions ordered by the healthcare facility over the predetermined time period have been received at the healthcare facility; and
updating the shipment status of the database with the third computer upon receiving and reading the prescription labels of the medication containers;
entering data in the third computer by scanning the machine readable code of the prescription labels on one or more medication containers at the healthcare facility and received from the pharmacy, which containers contain medication to be returned to the pharmacy;
storing the return prescription data having been entered for those medications to be returned to the pharmacy in the database as return prescription data;
entering prescription data on the first or second computer by scanning the machine readable code on prescription labels of one or more medication containers that have been returned to the pharmacy; and,
comparing, at the first or second computer, the prescription data of the returned medications having been entered at the first or second computer to the return prescription data entered at the healthcare facility to verify whether or not the medications returned from the healthcare facility have been received at the pharmacy.
